(19) United States
(12) Patent Application Publication
(10) Pub. No.: US 2015/0019244 A1
(43) Pub. Date: Jan. 15, 2015

(54) MEDICAMENT REGISTRATION APPARATUS AND MEDICAMENT REGISRATION METHOD

(71) Applicant: Toshiba Tec Kabushiki Kaisha, Tokyo (JP)

(72) Inventors: Yumiko Okuma, Tokyo-to (JP); Toshihide Murata, Izunokuni-shi (JP); Hirokazu Watanabe, Tokyo-to (JP); Shiomi Matsui, Izunokuni-shi (JP); Makoto Nozawa, Shizuoka-ken (JP); Yoshiaki Kumai, Mishima-shi (JP); Maki Sato, Yokohama-shi (JP); Shunichiro Kamamoto, Izunokuni-shi (JP); Ryu Morita, Mishima-shi (JP); Yasuhiro Nakajima, Izunokuni-shi (JP)

(21) Appl. No.: 14/326,671

(22) Filed: Jul. 9, 2014

(30) Foreign Application Priority Data
Jul. 11, 2013 (JP) 2013-145688

(51) Int. Cl. G06F 19/00

(52) U.S. Cl. CPC G06F 19/3456
USPC 705/2

(57) ABSTRACT

In accordance with one embodiment, a medicament registration apparatus comprises a registration module configured to register a medicament to be used in a storage section; a display control module configured to display each of the medicaments registered by the registration module in a list on a display section; and a reception module configured to receive a cancellation operation of cancelling the registration of the designated medicament in the medicaments registered by the registration module; wherein the registration module cancels the registration of the medicaments designated through the cancellation operation from the storage section; and the display control module displays the cancelled information indicating that the registration is cancelled corresponding to the medicament designated through the cancellation operation.

### CROSS-REFERENCE TO RELATED APPLICATION

This application is based upon and claims the benefit of priority from Japanese Patent Application No. 2013-145688, filed Jul. 11, 2013, the entire contents of which are incorporated herein by reference.

### FIELD

Embodiments described herein relate to a medicament registration apparatus and a medicament registration method.

### BACKGROUND

Conventionally, several systems have been proposed to prevent the occurrence of errors such as taking a medicament by mistake and the like. For example, in the system described in Japanese Unexamined Patent Application Publication No. 2002-163357, the medicament information specified by the barcode attached to the container of a medicament prepared to be prescribed is compared with information of a medicament that should be prescribed to prevent a wrong use of the medicament.

In an operating room, a nurse collects the empty medicament containers the medicaments in which are used in a surgery after the surgery, manually records the result of the collection on the used medicaments on a slip and delivers the slip to a pharmaceutical department. In addition, a nurse or a pharmacist who takes charge of recording the used medicaments information registers medicament names and quantities of the medicaments in a database and the like.

However, it may carry out a cancellation of registration after carrying out the registration of medicaments. For example, it is necessary to cancel a registered medicament in a case where an unused medicament is registered or in a case where the same medicament is registered repeatedly and the like. However, in the conventional technology described above, the cancellation of the registered medicament has not been taken into consideration yet, thus there remained a room for improvement in the convenience.

### BRIEF DESCRIPTION OF THE DRAWINGS

FIG. 1 is a block diagram illustrating the schematic configuration of a medicament management system according to an embodiment;

FIG. 2 is a front view illustrating the appearance of a medicament registration apparatus;

FIG. 3 is a block diagram illustrating the hardware constitution of the medicament registration apparatus;

FIG. 4 is a block diagram illustrating the functional components of the medicament registration apparatus;

FIG. 5 is a flowchart illustrating the flow of a used medicament registration processing carried out in the medicament registration apparatus;

FIG. 6 is an illustration diagram illustrating an example of a login screen;

FIG. 7 is an illustration diagram illustrating an example of a patient registration screen;

FIG. 8 is an illustration diagram illustrating an example of a medicament registration screen;

FIG. 9 is an illustration diagram illustrating an example of a medicament confirmation screen;

FIG. 10 is an illustration diagram illustrating an example of a medicament confirmation screen; and

FIG. 11 is an illustration diagram illustrating an example of a medicament confirmation screen.

### DETAILED DESCRIPTION

In accordance with one embodiment, a medicament registration apparatus comprises a registration module, a display control module and a reception module. The registration module registers the medicament to be used in a storage section. The display control module displays medicaments registered by the registration module in a list on a display section. The reception module receives a cancellation operation of cancelling the registration of the designated medicament in the medicaments registered by the registration module. In addition, the registration module cancels the registration of the medicament designated according to the cancellation instruction from the storage section. The display control module displays, corresponding to the medicament designated in the cancellation operation, the cancelled information indicating that the registration is cancelled.

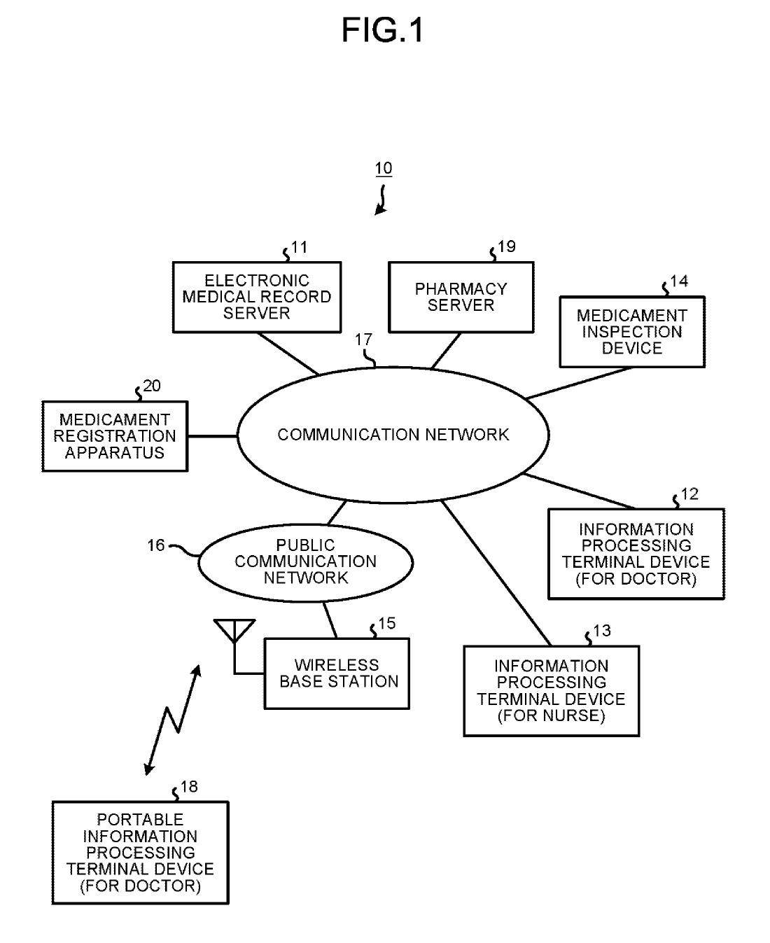

FIG. 1 is a block diagram illustrating the schematic configuration of a medicament management system 10 according to an embodiment. As shown in FIG. 1, the medicament management system 10 comprises an electronic medical record server 11, an information processing terminal device 12 for doctor, an information processing terminal device 13 for nurse, a medicament inspection device 14, a portable information processing terminal device 18 for doctor connected with a communication network 17 via a wireless base station 15 and a public communication network 16, a pharmacy server 19 and a medicament registration apparatus 20.

The electronic medical record server 11 is a device for managing and storing an electronic medical record. The information processing terminal device 12 for doctor is a device for carrying out recording of an electronic medical record and the like. The information processing terminal device 13 for nurse is a device for the reference to and the confirmation of the electronic medical record managed by the electronic medical record server 11. The medicament inspection device 14 is a device for supporting and inspecting the preparation of a medicament and the like based on the instruction information (e.g. prescription information) contained in the electronic medical record. The pharmacy server 19 is a device arranged in a pharmacy to manage a medicament delivery and the like. Further, the pharmacy server 19 registers the medicament information (name, dose, etc.) relating to a medicament corresponding to the code information or the external surface information (the feature amount indicating the label of the medicament or the feature amount indicating the surface states such as hue, concave-convex state and the like of the surface of the medicament) of the medicament in a table. The medicament registration apparatus 20 is an apparatus arranged in an operating room for supporting the registration of the medicaments used by a nurse in a surgery or the medicaments emergently used by a nurse or pharmacist in an emergency. In the present embodiment, the medicament registration apparatus 20 is an apparatus arranged in an operating room and assumed to be used by a nurse to register the medicaments used in a surgery.

In the configuration above, the electronic medical record server 11, the information processing terminal device 12, the information processing terminal device 13, the medicament inspection device 14, the pharmacy server 19 and the medicament registration apparatus 20 are connected with the communication network 17.

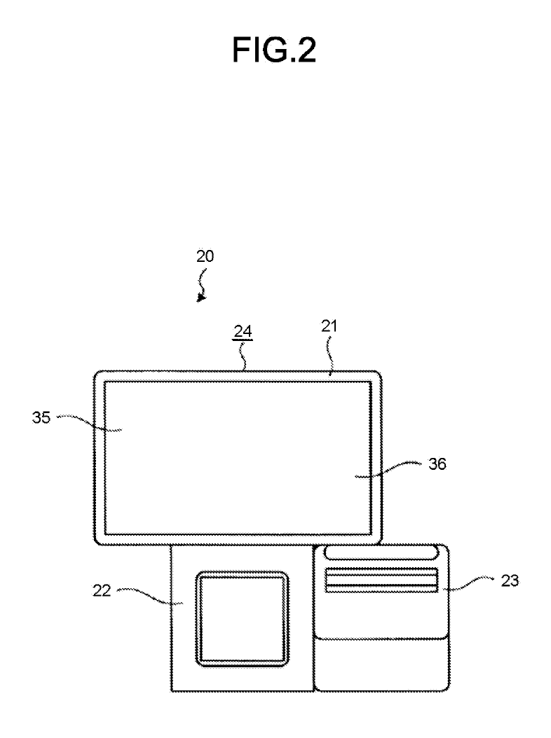

FIG. 2 is a front view illustrating the appearance of the medicament registration apparatus 20. As shown in FIG. 2, the medicament registration apparatus 20 roughly comprises an apparatus main body section 24 serving as the control main body of the medicament registration apparatus 20, a scanner 22 and a printer 23 for printing and outputting various kinds of information.

The apparatus main body section 24 comprises a touch panel display 21 for an operator, i.e., a nurse, to carry out various operations and for the display of various kinds of information such as a list of medicaments used in a surgery and the like.

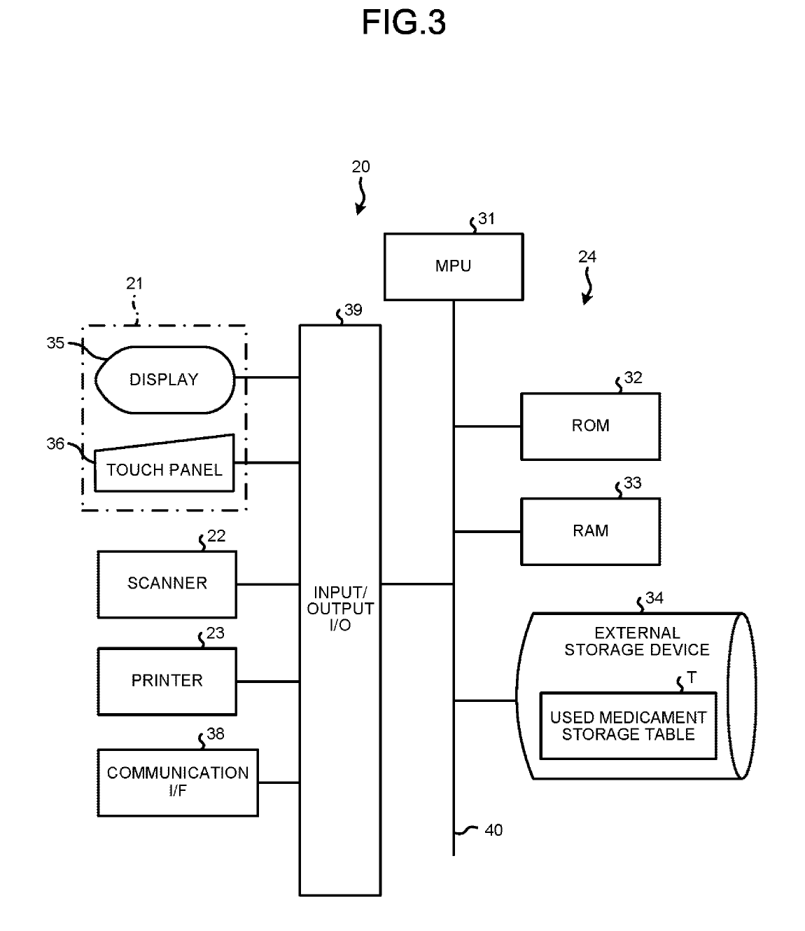

The scanner 22 comprises an image sensor (not shown) such as a color CCD (Charge Coupled Device) image sensor or a color CMOS (Complementary Metal-Oxide Semiconductor) image sensor and a light source (not shown) such as a LED (Light Emitting Diode). The scanner 22 photographs images of the code symbol of a nurse ID (Identification), the code symbol of a patient ID, the code symbol of a medicament, a medicament and the like. The frame images (imaged images) sequentially photographed by the scanner 22 at a given frame rate are stored in the under-mentioned RAM (Random Access Memory) 33 (refer to FIG. 3).

Further, the scanner 22 may vertically stand on ground but is not limited to be placed on the table shown in FIG. 2.

Further, the medicament registration apparatus 20 may further comprise a scale for weighting a medicament and a RFID reader-writer for reading or writing data from or into the RFID (Radio Frequency Identification) attached to a medicament.

FIG. 3 is a block diagram illustrating the hardware constitution of the medicament registration apparatus 20. As shown in FIG. 3, a MPU (Micro Processing Module) 31 for controlling the whole medicament registration apparatus 20, a ROM (Read Only Memory) 32, a RAM 33, an external storage device 34 and a communication interface (I/F) 38 for carrying out a communication interface operation are arranged in the apparatus main body section 24 of the medicament registration apparatus 20. The ROM 32 stores various kinds of data, including control programs, in a non-volatile manner. The RAM 33 functions as a working area to store various kinds of data temporarily. The external storage device 34 consists of a hard disk drive and a SSD (Solid State Drive) capable of storing high-capacity data and control programs (such as a database and the like)

Herein, the touch panel display 21, the scanner 22, the printer 23 and the communication interface 38 are connected with a bus line 40 via an input/output I/O 39. The bus line 40 is connected with the MPU 31, the ROM 32, the RAM 33 and the external storage device 34.

Further, the touch panel display 21 consists mainly of a display 35 serving as a display section and a touch panel 36.

Further, the external storage device 34 includes a used medicament storage table T in which the result of the collection on the medicaments used in a surgery is stored.

With such a structure, the MPU 31 of the medicament registration apparatus 20 operates according to the control programs stored in the ROM 32 and the external storage device 34 to carry out the registration support of the medicaments used in a surgery.

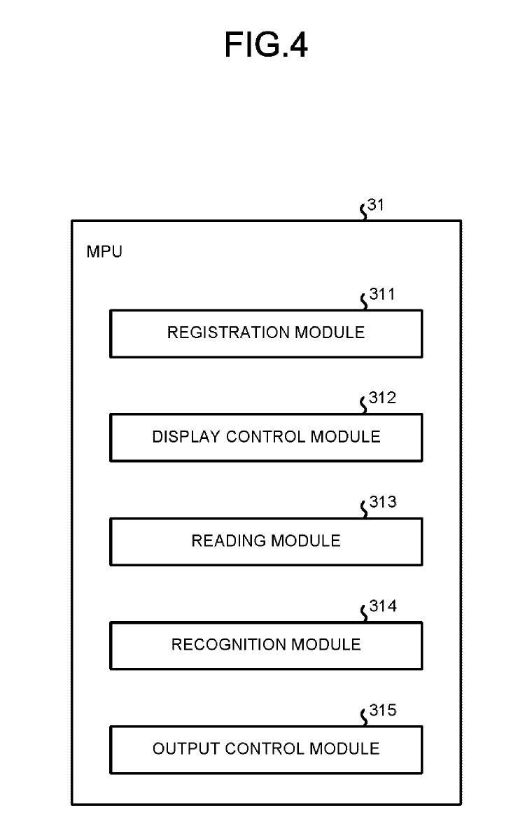

Next, the characteristic functions of the medicament registration apparatus 20 according to the embodiment are described. FIG. 4 is a block diagram illustrating the functional components of the medicament registration apparatus 20. The MPU 31 operates according to the control programs stored in the ROM and the external storage device 34 to function as a registration module 311, a display control module 312, a reading module 313, a recognition module 314 and an output control module 315, as shown in FIG. 4. Further, by cooperating with the touch panel display 21, the registration module 311 and the display control module 312, the MPU 31 also functions as a reception module (not shown) for receiving the instructing operation from an operator (a nurse).

The reading module 313 reads the code information of the code symbol attached to a medicament used in a surgery or all or part of the external surface information (the feature amount indicating the label of the medicament or the feature amount indicating the surface states, such as hue, concave-convex state and the like of the surface of the medicament) of a medicament used in a surgery from the image scanned and photographed by the scanner 22. The detection processing of the code information according to a code symbol such as a barcode or a two-dimensional code can be carried out using the conventional technology and is therefore not described herein.

The recognition module 314 recognizes the medicament based on the code information or the external surface information (referred hereinafter to as medicament ID) as a reading result read by the reading module 313. Further, in a method of recognizing a medicament based on code information, the medicament information (name, dose, etc.) of a medicament is stored as a table corresponding to code information in advance, and the medicament can be recognized by extracting the medicament information of the medicament based on the code information from the table. Further, in a method of recognizing a medicament based on external surface information (the feature amount indicating the label of a medicament or the feature amount indicating the surface states such as hue, concave-convex state and the like of the surface a medicament), the external surface information of a medicament is stored as a table corresponding to code information in advance, and the medicament can be recognized by extracting the medicament information of the medicament based on the external surface information from the table.

The registration module 311 registers the medicament used in a surgery and recognized by the recognition module 314 in the used medicament storage table T of the external storage device 34 functioning as a storage section. Further, if a cancellation operation instructing the operator to cancel the registration of any of the registered medicaments is received, the registration module 311 carries out the cancellation of registration of a medicament by cancelling the medicament from the used medicament storage table T. In addition, if a release operation instructing the operator to release the cancellation of any of the medicaments as a cancellation operation target is received, the registration module 311 registers the medicament in the used medicament storage table T once again.

The display control module 312 displays a list of the medicament information of the medicament registered by the registration module 311 on the display 35 serving as a display section. Further, the display control module 312 displays each GUI (Graphical User Interface) relating to medicament registration on the display 35. In addition, the display control module 312 displays the cancelled information indicating that the registration is cancelled according to the cancellation operation of the medicament by corresponding to the medicament information of the medicament. In addition, when a release operation to the medicament as cancellation operation target is received, the display control module 312 erases the cancelled information displayed corresponding to the medicament information of the medicament.

The output control module 315 outputs a medicament slip on which detailed content (medicament ID, medicament information, quantity, etc.) of a registered medicament in the medicaments displayed in the list is recorded. Further, the medicament slip and a borrow slip may be sent to an external device via the communication network 17 to be output, but are not limited to be printed and output using the printer 23.

Next, a used medicament registration processing is described which is carried out according to a control program by the MPU 31 of the medicament registration apparatus 20 according to the embodiment described above. The medicament registration apparatus 20 according to the embodiment scans the code symbol and the image of a medicament used in a surgery and executes a used medicament registration processing after the surgery.

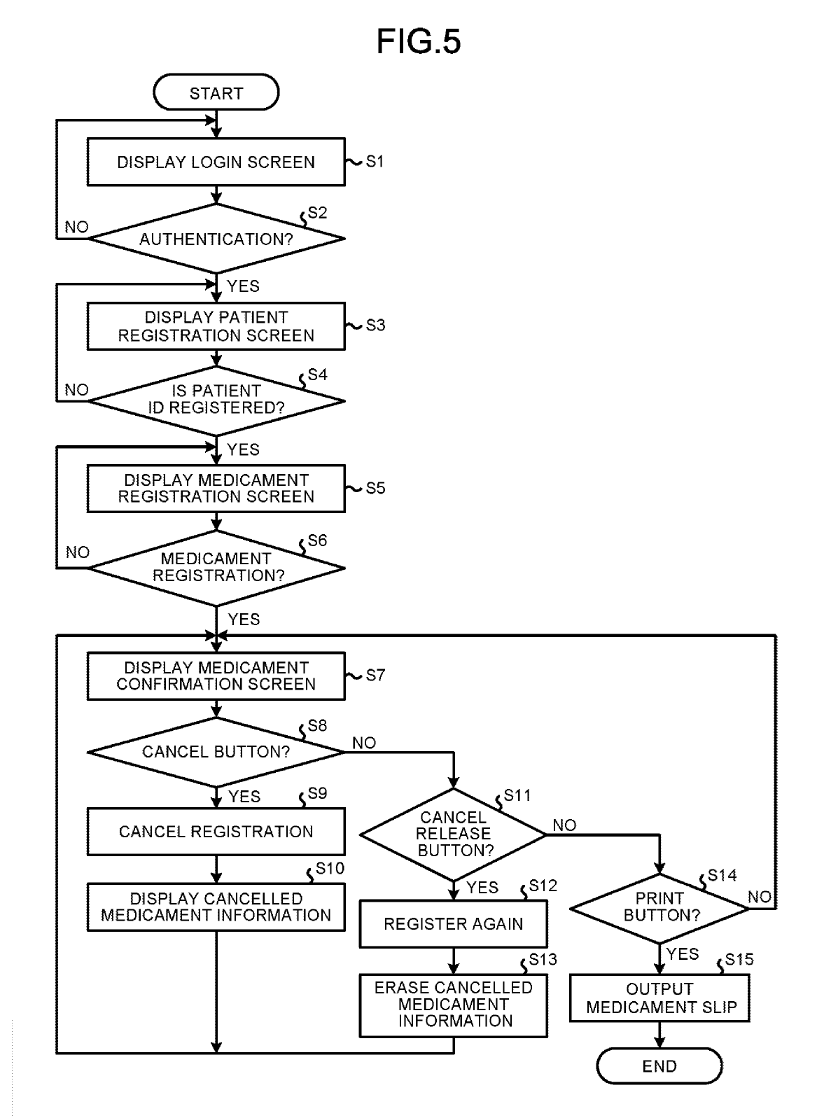

FIG. 5 is a flowchart illustrating the flow of a used medicament registration processing carried out by the MPU 31 of the medicament registration apparatus 20 according to a control program. As shown in FIG. 5, the MPU 31 of the medicament registration apparatus 20 displays a login screen on the display 35 as an initial state (ACT S1). It is assumed that each operator permitted to operate the medicament registration apparatus 20 has an ID card with which the operator can be authenticated to operate the medicament registration apparatus 20.

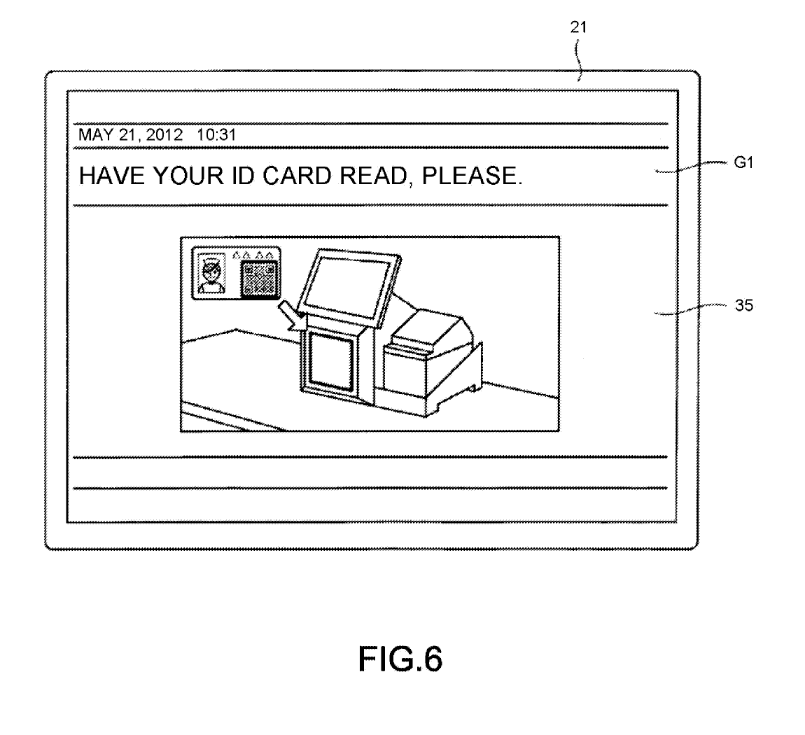

FIG. 6 is an illustration diagram illustrating an example of a login screen G1. A guide comment of “Have your ID card read, please.” and a guide image for urging the scanner 22 to read the code symbol of the nurse ID attached to an ID card are displayed on the login screen G1, as shown in FIG. 6.

Thus, to carry out a login processing, the operator holds the code symbol of the nurse ID attached to his/her ID card in front of the scanner 22 for the scanner 22 to read the nurse ID.

If the nurse ID is authenticated through a login processing (YES in ACT S2), the MPU 31 of the medicament registration apparatus 20 displays a patient registration screen on the display screen of the display 35 (ACT S3). In addition, if the nurse ID is not authenticated (NO in ACT S2), the MPU 31 of the medicament registration apparatus 20 returns to ACT Si to display the login screen G1 again.

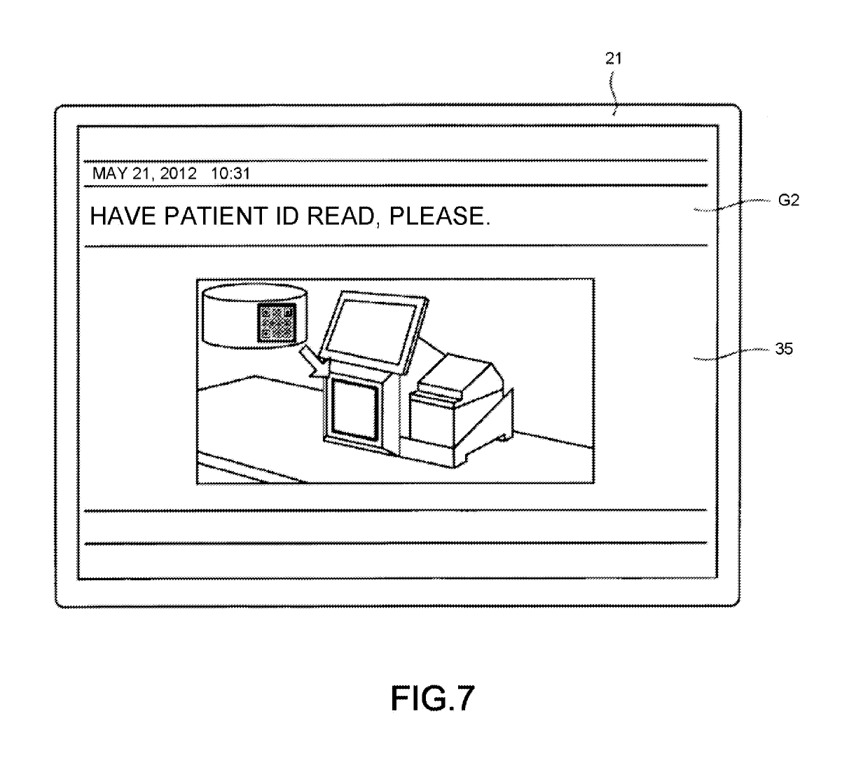

FIG. 7 is an illustration diagram illustrating an example of a patient registration screen G2. A guide comment of ‘Have a patient ID read, please.’ and a guide image for urging the scanner 22 to read the code symbol of the patient ID attached to the wristband of a patient are displayed on the patient registration screen G2, as shown in FIG. 7.

Thus, to carry out a patient registration processing, the operator holds the code symbol of the patient ID attached to the wristband of the patient in front of the scanner 22 for the scanner 22 to read the patient ID.

If the patient ID is registered through a patient registration processing (YES in ACT S4), the MPU 31 of the medicament registration apparatus 20 displays a medicament registration screen for the registration of a medicament additionally used in a surgery on the display screen of the display 35 (ACT S5). In addition, if the patient ID is not registered (NO in ACT S4), the MPU 31 of the medicament registration apparatus 20 returns to ACT S3 to display the patient registration screen G2 again.

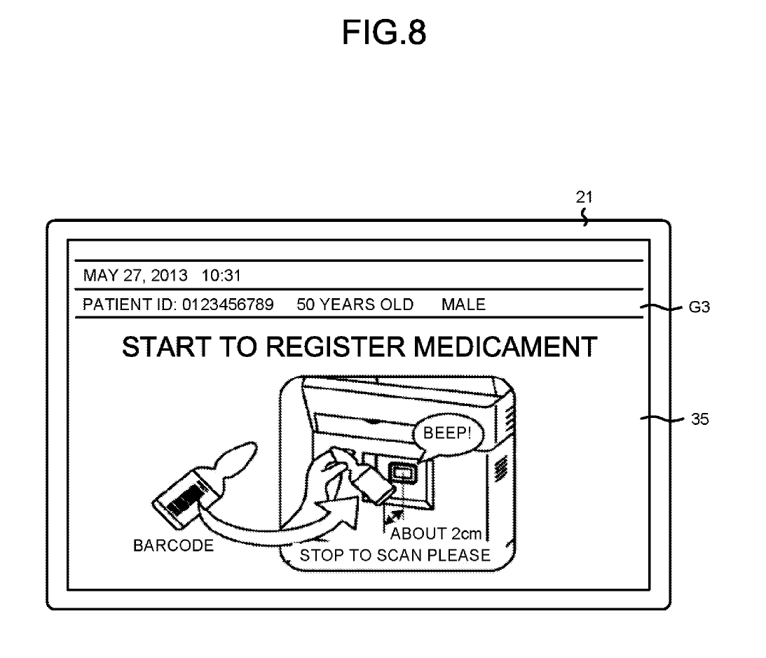

FIG. 8 is an illustration diagram illustrating an example of a medicament registration screen G3. A guide comment of “Start to register medicament” and a guide image for urging the scanner 22 to read the code symbol of the medicament ID attached to a medicament are displayed on the medicament registration screen G3, as shown in FIG. 8. Further, the patient ID and patient information (e.g. age, gender, etc.) of the patient specified by the patient ID read from the patient registration screen G2 are also displayed on the medicament registration screen G3 (in the following figures, the patient ID and the patient information are all the same).

To carry out a medicament registration processing based on the medicament registration screen G3, the operator holds the code symbol of the medicament ID attached to a medicament in front of the scanner 22 for the scanner 22 to read the medicament ID.

The MPU 31 of the medicament registration apparatus 20 enters a standby state until the medicament ID is read (NO in ACT S6). When the medicament ID is read, the MPU 31 of the medicament registration apparatus 20 extracts the medicament information corresponding to the medicament ID from the table and stores the resulting medicament information by associating the medicament ID with the quantity in the RAM 33 and the like. Moreover, after the stored medicament ID and the medicament information as well as the quantity and the like are registered in the used medicament storage table T (YES in ACT S6), the MPU 31 of the medicament registration apparatus 20 displays a medicament confirmation screen on the display screen of the display 35 (ACT S7). In addition, after ACT S7, the MPU 31 of the medicament registration apparatus 20 registers a new medicament ID every time a new medicament ID is read by the scanner 22 which continues to read a medicament ID in the background.

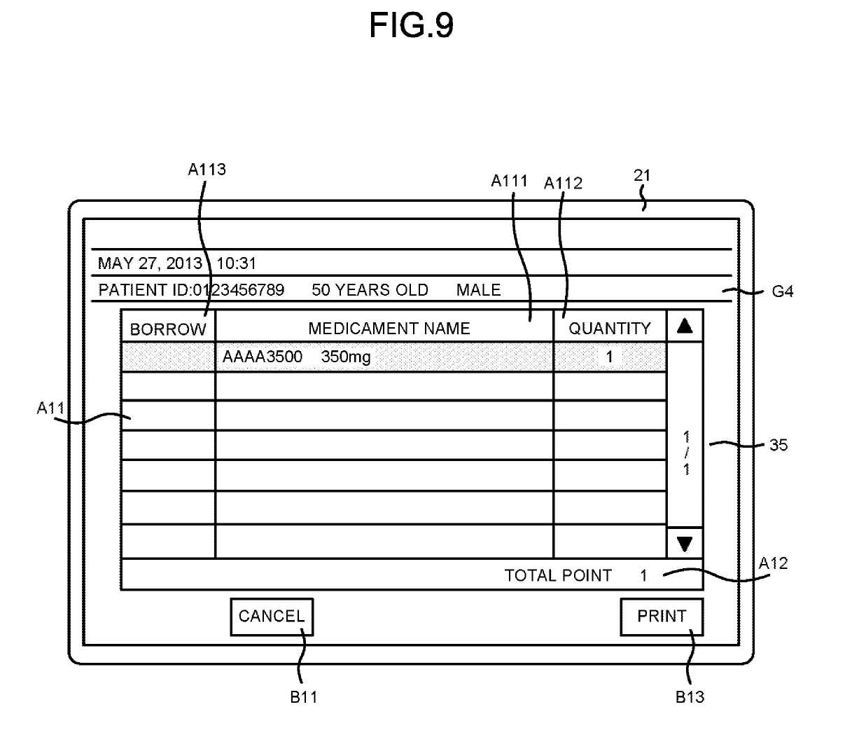

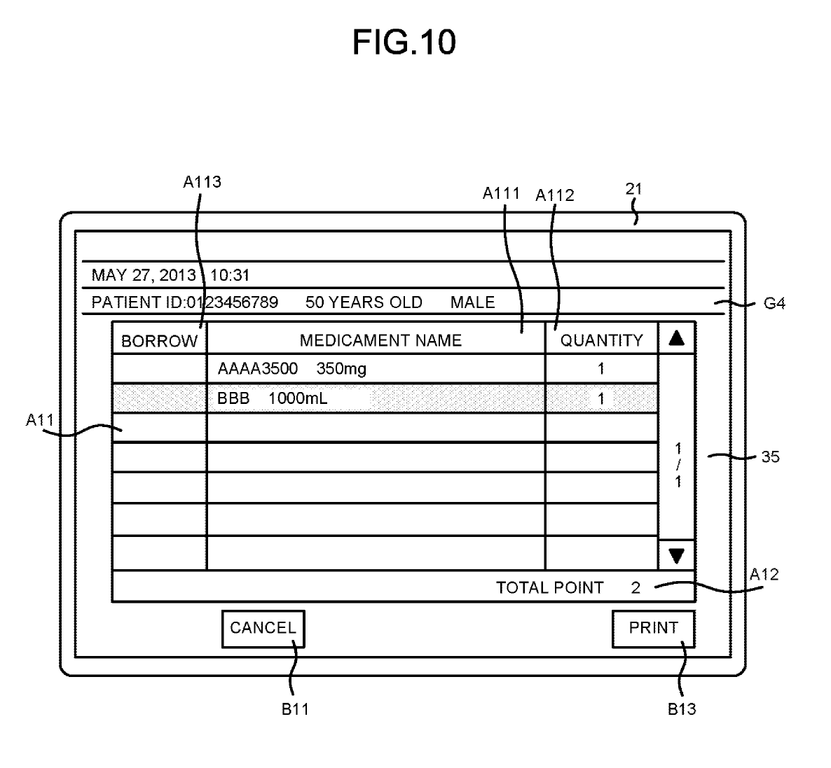

FIG. 9 and FIG. 10 are illustration diagrams respectively illustrating an example of a medicament confirmation screen G4. The medicament confirmation screen G4 includes a list display column A11, a total point column A12, a Cancel button B11 and a Print button B13. The list display column A11 includes a medicament name item A111 for displaying medicament information (name, dose, etc.), a quantity item A112 for displaying a medicament quantity and a borrow item A113 for displaying a borrow icon which will be described later. In the list display column A11, the medicament information (name, dose, etc.) and the quantity obtained from a registered medicament are displayed in the medicament name item A111 and the quantity item A112 in a list, respectively. Further, the MPU 31 of the medicament registration apparatus 20 sums up the total quantity of the registered medicaments and displays the obtained value in the total point column A12 as a total point.

For example, when a new medicament ID is registered through a medicament registration processing, the MPU 31 of the medicament registration apparatus 20 additionally displays the medicament information of the medicament according to the new medicament ID on the list display column A11. Further, the MPU 31 of the medicament registration apparatus 20 explicitly presents the medicament information of a new registered medicament to an operator by highlighting the medicament information.

However, in practice, there is such a case in which the registration of a medicament is cancelled after the medicament is registered. For example, it is necessary to cancel the registered medicament in a case where an unused medicament is registered or in a case where the same medicament is registered repeatedly and the like. Therefore, it becomes possible for the medicament registration apparatus 20 according to the present embodiment to instruct an operator to cancel the registration with the Cancel button B11.

Specifically, the operator designates the medicament to be cancelled (hereinafter referred to as cancellation medicament) in the registered medicaments from the list display column A11 and operates the Cancel button B11. When the designation of the cancellation medicament and the operation of the Cancel button E11 are received (YES in ACT S8), the MPU 31 of the medicament registration apparatus 20 cancels the registration by cancelling the information of the designated cancellation medicament registered in the used medicament storage table T (ACT S9). Moreover, the MPU 31 of the medicament registration apparatus 20 displays the cancelled information indicating that the registration is cancelled corresponding to the cancellation medicament displayed in the list display column A11 (ACT S10) and returns to ACT S7.

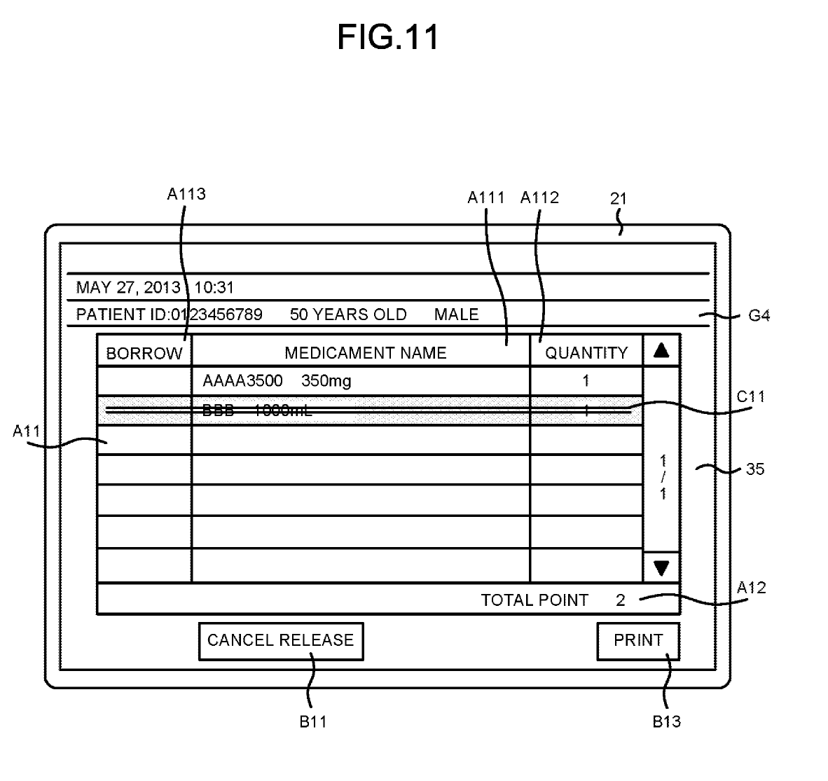

FIG. 11 is an illustration diagram illustrating an example of the medicament confirmation screen G4. A state in which the cancellation operation is carried out to the medicament (cancellation medicament) the medicament name of which is “BBB 1000 mL” is shown on the medicament confirmation screen G4 in FIG. 11. Herein, a strikethrough C11 is added (superimposed) in the entry where the medicament name is “BBB 1000 mL” as cancelled information.

In this way, in the medicament registration apparatus 20 according to the present embodiment, the cancellation of the registration of the registered medicaments is easily carried out, thus the management of medicaments can be performed effectively. Further, in the medicament registration apparatus 20 according to the present embodiment, the medicament of which the cancellation of the registration is carried out is not erased from the list display column A11 but is continued to be displayed in a state where a strikethrough C11 (cancelled information) is added. In this way, the operator can determine which one of the medicaments is cancelled at a glance, thereby obtaining an effective management of medicaments and improving the convenience.

In addition, in a case in which the medicament added with the cancelled information, i.e., the cancelled medicament is designated from the list display column A11, the MPU 31 of the medicament registration apparatus 20 replaces the Cancel button B11 with a Cancel Release button B12 and display it as shown in FIG. 11. Herein, the Cancel Release button B12 is an operator for carrying out a release operation of releasing the cancellation of the medicament of which the cancellation of registration is carried out.

Specifically, the operator designates the medicament to be released (hereinafter referred to as release target medicament) in the medicaments of which the cancellation of registration is carried out from the list display column A11 and operates the Cancel Release button B12. If the designation of the release target medicament and the operation of the Cancel Release button B12 are received (NO in ACT S8 and YES in ACT S11), the MPU 31 of the medicament registration apparatus 20 registers the stored medicament ID, the medicament information and quantity of the designated release target medicament in the used medicament storage table T again (ACT S12). In addition, the MPU 31 of the medicament registration apparatus 20 erases the cancelled information which has been displayed corresponding to the release target medicament (ACT S13), and returns to ACT S7 (refer to FIG. 10).

In this way, in the medicament registration apparatus 20 according to the present embodiment, the release of the cancellation can be easily carried out for the medicament of which the cancellation of the registration is carried out, and therefore the management of medicaments can be effectively carried out. For example, in a case where a medicament is used in practice after the unused medicament which is registered by mistake is cancelled, the medicament can be newly registered by operating the Cancel Release button B12, and there is no need to read the medicament again by the scanner 22, therefore the processing can be effectively performed.

Further, in the medicament confirmation screen G4, the Print button B13 is an operator for instructing the output of the medicament slip. If the operation of the Print button B13 is received (NO in ACT S8, NO in ACT S11 and YES in ACT S14), the MPU 31 of the medicament registration apparatus 20 outputs the medicament slip on which the medicament ID, medicament information and quantity of the registered medicament are recorded from the printer 23 (ACT S15), and ends the processing. Herein, the registered medicament refers to the medicament which is not in association with the cancelled information in the medicaments displayed in the list display column A11.

Further, in the medicament confirmation screen G4, in a case where neither the Cancel button B11 (Cancel Release button B12) nor the Print button B13 are operated (NO in ACT S8, NO in ACT S11 and NO in ACT S14), the processing returns to ACT S7.

As stated above, the cancellation of the registered medicament and the release of the corresponding cancellation can be carried out through the medicament confirmation screen G4 displayed on the display 35 of the medicament registration apparatus 20 according to the present embodiment. In this way, it is possible to carry out the cancellation of the registered medicament and the release of the corresponding cancellation easily, thus the management of medicaments can be effectively carried out.

The registration of a medicament additionally used in a surgery is described in the present embodiment; however, the present invention is not limited to this. For example, it may be a registration of a medicament used in the medical work other than a surgery. In addition, a medicament which may be additionally used in a surgery may be registered before a surgery in advance, which prevents a wrong use of a medicament before medicaments are administered.

Further, the control program executed by the medicament registration apparatus 20 in the present embodiment may be stored in an installable or executable file in a computer-readable recording medium such as CD-ROM, flexible disk (FD), CD-R, DVD (Digital Versatile Disk) and the like.

Further, the control program executed by the medicament registration apparatus 20 in the present embodiment may be stored in a computer connected with a network such as the Internet to be provided after being downloaded from the network or provided or distributed via a network such as the Internet and the like.

The control program executed by the medicament registration apparatus 20 in the present embodiment may be incorporated in a ROM and the like in advance.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the embodiment described above, it is assumed that the registration of the designated medicament is cancelled every time the cancellation operation is carried out; however, the present invention is not limited to this. For example, the MPU 31 of the medicament registration apparatus 20 may collectively cancel the registration of all the medicaments designated through the cancellation operation so far at the timing when the operation of the Print button B13 and the operation of instructing the ending of registration are carried out. In this case, the cancelled information is displayed corresponding to the medicament designated through the cancellation operation, and if the release operation is received, the display of the cancelled information is erased. In this way, with the cancellation operation and the release operation, the number of times (frequency) of access to the used medicament storage table T may be suppressed, thus the processing can be performed effectively.

What is claimed is:

1. A medicament registration apparatus comprising:
a registration module configured to register a medicament to be used in a storage section;
a display control module configured to display each of the medicaments registered by the registration module in a list on a display section; and
a reception module configured to receive a cancellation operation of cancelling the registration of the designated medicament in the medicaments registered by the registration module; wherein
the registration module cancels the registration of the medicaments designated through the cancellation operation from the storage section; and
the display control module displays the cancelled information indicating that the registration is cancelled corresponding to the medicament designated through the cancellation operation.

2. The medicament registration apparatus according to claim 1, wherein
the reception module receives a release operation of releasing the cancellation of the designated medicament in the medicaments as the cancellation operation target;
the registration module registers the medicament designated through the release operation in the storage section again; and
the display control module erases the cancelled information of the medicament designated through the release operation.

3. The medicament registration apparatus according to claim 1, wherein
the display control module adds a strikethrough as the cancelled information to the medicament designated through the cancellation operation.

4. The medicament registration apparatus according to claim 1, wherein
the reception module displays an operator for receiving a cancellation of the registration or a release of the cancellation on the display section and receives operations on the operators.

5. The medicament registration apparatus according to claim 1, further comprising:
an output control module configured to output a slip relating to the medicament registered in the storage section in the medicaments displayed in the list.

6. A medicament registration method carried out by a medicament registration apparatus comprising a registration module configured to register a medicament to be used in a storage section, a display control module configured to display each of the medicaments registered by the registration module in a list on a display section, and a reception module configured to receive a cancellation operation of cancelling the registration of the designated medicament in the medicaments registered by the registration module, including:
cancelling the registration of the medicaments designated through the cancellation operation from the storage section; and
displaying the cancelled information indicating that the registration is cancelled corresponding to the medicament designated through the cancellation operation.
